(19) United States
(12) Patent Application Publication
(10) Pub. No.: US 2003/0161980 A1
(43) Pub. Date: Aug. 28, 2003

(54) Plastic container

(76) Inventor: Brent S. Nelson, Bradenton, FL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/083,975

(22) Filed: Feb. 27, 2002

(51) Int. Cl. B32B 1/02

(52) U.S. Cl. 428/36.7; 428/35.7

(57) ABSTRACT

A plastic container, especially suitable for long-term storage of beverages that are hot filled into the containers, having in one embodiment four relatively flat vacuum panels, having in another embodiment a seven layer polymeric material with a nylon interior layer, and having in another embodiment a combination of the other embodiments.

### DESCRIPTION

1. Field of the Invention

The present invention is directed to plastic containers. More specifically, the present invention relates to blow molded shaped plastic containers, particularly beverage containers. A first aspect of the present invention is directed to the panel design for hot fillable plastic containers, such as those for hot fill beverages. More specifically, this first aspect of the present invention is directed to a panel design for hot fillable plastic containers having flat vacuum side panels. A second aspect of the present invention is directed to multi-layer plastic containers. More specifically, this aspect of the present invention is directed to plastic containers having a seven layer polymer structure. A third aspect of the present invention is directed to plastic containers having the panel design of the first aspect and the seven layer structure of the second aspect of the present invention.

### BACKGROUND OF THE INVENTION

Hot filled containers are designed for packaging of liquids which must be placed in the container while hot to provide for adequate sterilization. During filling, the container is subjected to elevated temperatures of approximately 180° to 185° F. (the product temperature) and positive internal pressures of approximately 2 to 5 psi (the filling line pressure). The container is then capped, and as the product cools, a negative internal pressure is formed in the sealed container. The hot fill, however, can cause distortion and shrinkage of the container. It is desired that the volumemetric shrinkage be limited to no greater than 1%.

Many different types of containers have been created to receive a hot-fill product and meet the objectives of a minimum amount of thermal shrinkage and distortion. However, prior efforts to produce bottles for handling hot filling and to meet the above objections have necessarily included panels having indents, detents, protruding surfaces and/or recessed surfaces functioning as so-called vacuum panels for container stress relief.

For example, U.S. Pat. No. 4,863,046 (Collette et al.) discloses a blow molded container for receiving a hot fill product. The container in the '046 patent, however, does not have flat side panels but instead has a series of indents or recessed portions and ribs in the side panels in order to minimize shrinkage and increase longitudinal stiffness of the panel section.

Another patent disclosing a plastic container with vacuum panels is U.S. Pat. No. 5,704,503 (Krishnakumar). The container in the '503 patent also does not have flat vacuum panels, but instead requires longitude post ribs flanked by walls, in between recessed vacuum panels. Hoop ribs are also provided around the panel.

U.S. Pat. No. 4,877,141 (Hayashi et al.) shows another type of vacuum panels. The '141 patent also does not have flat panels, but rather the panels have stress absorbing strips to prevent deformation of the container. Each panel is also surrounded by outer sheaths.

Accordingly, these prior containers taught the need to have specially designed structures to accommodate volume changes upon cooling of hot filled products. These containers did not have flat vacuum panels.

Therefore, one object of an embodiment of the present invention is to provide a flat vacuum panel structure, without the need for any such ribs or stress absorbing strips. This provides smooth sides for ease of label application and cleanness of appearance, while still maintaining a sufficient top load rating. The smooth sides also provide an appealing feel for the consumer, especially in the label area which does not suffer from the wrinkled feel of labels on prior containers.

Another aspect of plastic containers relates to the plastic polymer used to mold the container. Frequently, a multilayer polymer composition is used to provide strength and other benefits to the container.

For example, U.S. Pat. No. 4,182,457 (Yamada) discloses a multi-layer container and several embodiments thereof, including some with seven layers. Some are mentioned at columns 9 and 28 therein. These structures, however, have a polyolefin as the innermost layer. Polyolefins have been found to rapidly strip the limonene out of fruit or citrus juices. This adversely affects the taste of the juice as limonene and other important flavor and color components contribute to desirable tangy flavors and color of the juices.

U.S. Pat. No. 4,990,382 (Weissenstein et al.) discloses laminated blow molded containers which are said to provide a glass like appearance. The '382 patent also discloses some containers with seven layer structures. In these containers, the interior layer is a polypropylene followed by a layer of adhesive, a barrier layer, another layer of adhesive, a relatively thick layer formed of regrind scrap containers, a third layer of adhesive and an outside gloss coat layer formed from plastic materials including ethylenelvinyl alcohol copolymer (EVOH) and nylon and mixtures thereof. Since this container has polypropylene, a polyolefin, as the inner most layer, the container will quickly strip the limonene and other important flavor and color components out of fruit juice therein and adversely affect the taste and color of the juice.

Reissue U.S. Pat. No. Re 34,546 (Deyrup) is directed to the use of high density linear polyethylene for containers and also generally discloses the use of seven layer structures for containers. Deyrup '546 recites for example a seven layer structure including polyethylene, adhesive, EVOH, adhesive, polyethylene, adhesive and polyamides or nylons. While an amorphous polycarboxlamide is used as an inner layer in some of the structures of this patent, neither a layer of polypropylene nor a layer of regrind is used.

Therefore, an object of the present invention is to provide a plastic container having a specific seven layer structure which is suitable for storage of beverages of juices, dairy products and combinations thereof and which will not adversely affect the taste and color of the beverages therein.

Still another object of the present invention is to provide a plastic container having a flat vacuum panel structure and a specific seven layer structure which is suitable for storage of beverages of juices, dairy products and combinations thereof.

### SUMMARY OF THE INVENTION

The present invention is directed to plastic containers including those formed by blow molding, which are especially suitable for long-term storage of beverages that are hot filled into the containers.

In a first embodiment of the present invention, the container has a rectangular cross-section body portion with four panels wherein each of the four panels is relatively flat, but flexible. These panels function as vacuum panels which buckle slightly inwardly in response to cooling of the hot filled liquid. The panels can move from a planar configuration and a bowed configuration in response to filling with hot product and cooling after filling. By having virtually flat panels, label application to the container is simplified while providing a smooth, aesthetically pleasing look and feel.

In a second embodiment of the present invention, the container has walls formed of a polymeric material having a seven layer structure of polypropylene, adhesive, EVOH, adhesive, regrind, adhesive, and amorphous nylon. Preferably, the polypropylene forms the outside of the container wall while the amorphous nylon forms the innermost layer which contacts the contents of the container. The amorphous nylon layer prevents the beverages from losing their color and taste, due to either scalping of key favor and color components out of the juice and into the plastic and/or imparting from the plastic off note plastic flavors into the juice. The other layers provide strength and a barrier layer for contaminants.

In a third embodiment of the present invention, the container has the flat panel walls of the first embodiment and is formed as a polymeric material having the seven layer structure of the second embodiment.

### BRIEF DESCRIPTION OF THE DRAWINGS

FIG. 1 is a perspective view of a beverage container of a first embodiment of the present invention.

FIG. 2 is an elevational view of the container of FIG. 1.

FIG. 3 is a top plan view of the container of FIG. 1.

FIG. 4 is a bottom plan view of the container of FIG. 1.

FIG. 5 is a perspective view of another example of a container of the first embodiment of the present invention.

FIG. 6 is an elevational view of the container of FIG. 5.

FIG. 7 is a cross-sectional view of the seven layers of the polymeric material of a container of a second embodiment of the present invention.

### DETAILED DESCRIPTION OF THE PRESENTLY PREFERRED EMBODIMENTS

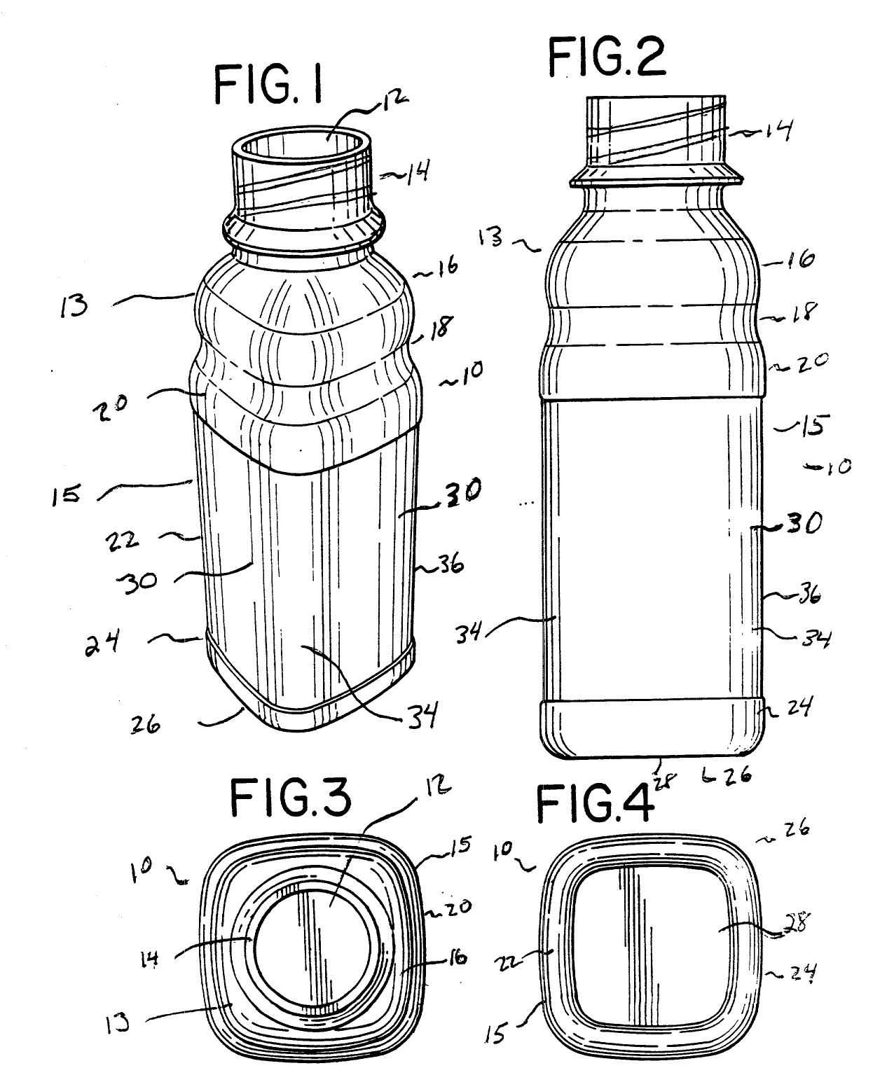

FIGS. 1-4 show a first embodiment of the present invention. This embodiment is directed to a plastic container 10, preferably a beverage bottle, for hot fill liquids. The bottle includes an open mouth 12 to receive hot fillable liquids, a bell (or upper) area or portion 13, and a body (or lower) area or portion 15.

Concerning the bell area 13, surrounding the mouth 12 is a neck 14 to receive a cap [not shown]. Preferably, the neck 14 has threads for screwing on the cap. Below the neck is a shoulder section 16 which increases generally in width from the neck to a maximum point, lower on the container. The width then decreases to a recessed area 18. Then, below the recessed area 18 is a first elevated ridge 20. This bell area helps to provide an acceptable top load rating for the container. The top load rating relates to the ability of the container to have other items, particularly other containers, stacked thereon. In this embodiment, a top load rating of at least 80 pounds has been achieved. The bell area 13 is able to provide sufficient strength so that it is not necessary for the body portion 15 to provide a means for supporting a top load weight which could include indents, detents, protruding surfaces and/or recessed surfaces.

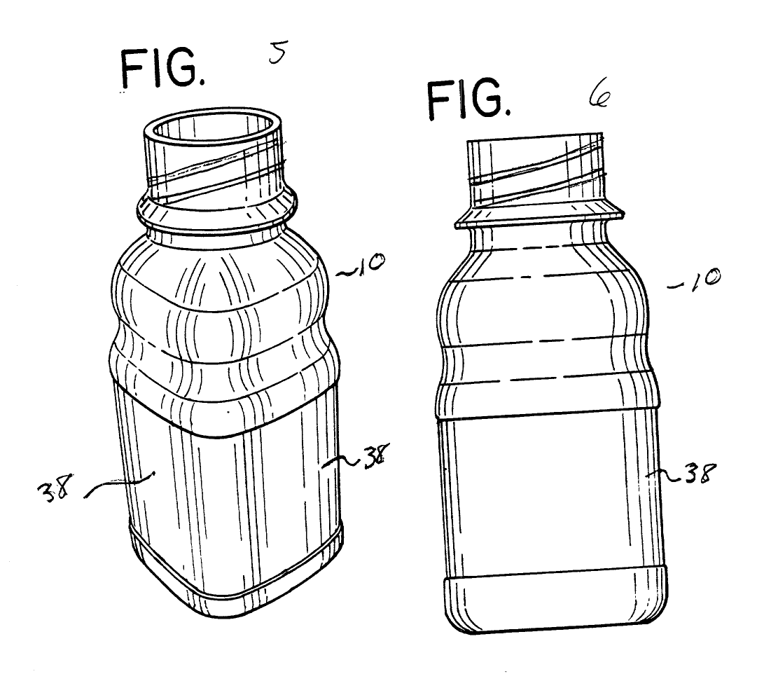

The body portion 15 is generally defined as follows. The body portion 15 includes below the first elevated ridge 20 a rectangular (longitudinally) lower body portion or panel section 22. Below the panel section 22 is a second elevated ridge 24 and a base 26. As shown, the elevated ridges 20 and 24 have a greater width (in transverse bottle cross section) than the panel section 22. Ridges 20 and 24 act to isolate the panel section and allow the panel section to act as vacuum panels. These ridges also act as bumpers for the bottles to keep the bottles flush to one another on a conveyor belt during filling and/or capping and to keep them moving along the conveyor belt. The ridges could also operate as protection for a label located only on the side panels. Base 26 preferably includes a recessed closed bottom 28 as shown in FIG. 4 which moves inwardly to cooperate with the panel section 22 in order to reduce the negative pressure during product cooling.

Preferably, the panel section 22 has a transverse cross-sectional shape which is square but is not limited to this shape. More preferably, the panel section has four flat side panels which are rectangular. Typically, the side panels are substantially identical in size, shape, thickness and composition. In a further embodiment, the mold line (not shown) for the container is located on two opposing side panels, as opposed to in the corners. In this embodiment, these opposing side panels may be slightly thicker than the other side panels.

Each side panel 30 is not only flat but flexible and has no ribs, stress absorbing strips, recessed areas, or other similar obstructions to panel bowing. Each of the side panels preferably has smooth corners 34 between the two panels. A label can then be smoothly and easily applied to the bottle. For example, a label 36 could extend from the top shoulder 16 to base 26. The present invention, however, is not limited to the size or length of the label.

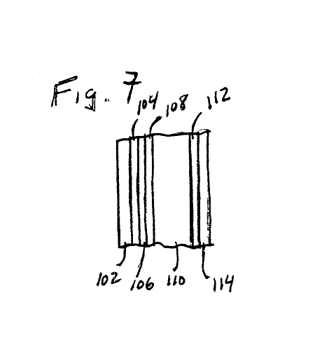

While FIGS. 1-4 show the side panels having a long longitudinal length, the panels can be of any length as for example shown in FIGS. 5-6. In these figures, side panel 38 has a much shorter height. Otherwise, the plastic container of FIGS. 5-6 is essentially the same as the container shown in FIGS. 1-4.

The second embodiment of the present invention is directed to a plastic container formed of a polymeric material and having a seven layer structure. FIG. 7 is a cross-sectional view of the seven layers in the plastic polymeric material of the walls of the container. In this embodiment, the plastic polymeric material has four structural layers and three adhesive layers.

As shown in FIG. 7, the exterior surface 102 of the container of this embodiment is made of polypropylene, such as a virgin polypropylene. The mid-outer layer 104 is an adhesive. The mid-interior layer 106 is ethylene-vinyl alcohol polymer (EVOH). The next layer 108 is another layer of adhesive. The next layer 110 is a re-grind layer. It is an interior, sandwiched layer. This is a “scrap” of the seven layer co-extrusion which has been collected and ground into polymer. Preferably the bulk of the co-extrusion is the re-grind material, making up to approximately 70 percent of the total thickness of the extrusion. The next layer is another adhesive layer 112. These layers act as a barrier to keep contaminants from the beverage and to give strength to the container. As a result, the beverage within the container will have a longer shelf life than other containers with such a combination of layers. The contact or innermost layer 114 is a polyamide, such as an amorphous nylon. It is the amorphous nylon layer which contacts the contents of the container, such as a beverage within the container. The nylon layer does not strip the limonene and other important flavor and color components out of the beverage. As a result, a fruit or citrus containing beverage will maintain its tangy flavor and color longer and will not have a plastic taste.

The following is an example of a plastic container having a seven layer construction in accordance with this embodiment of the present invention. Preferably, for a 12-ounce container such as shown in FIG. 1, the weight of the bare bottle is 27 grams. Materials used included a polypropylene (Marlex®) manufactured by Phillips, manufacturer No. RGN-020; an EVOH (Soarnol®) from Soarus, manufacturer No. DCF3203F; and a nylon from Dupont (Selar®), manufacturer No. PA3426. An adhesive from Dupont (Bynel®), manufacturer No. CXA 50E571, was used for each of the adhesive layers. These materials were used in a polymeric composition having the composition shown in Table 1 to produce a plastic beverage container in accordance with the present invention.

TABLE 1

| | | Target | |
|---|---|---|---|
| Layer | Material | Thickness (in) | % of thickness |
| Outer | Virgin Polypropylene | 0.006 | 20 |
| Mid-outer | Adhesive | 0.0004 | 1.3 |
| Mid-inner | EVOH | 0.0006 | 2 |
| | | (minimum) | |
| Mid-inner 1 | Adhesive | 0.0004 | 1.3 |
| Inner | Regrind | 0.0216 | 72 |
| Lower-inner | Adhesive | 0.0004 | 1.3 |
| Contact | Amorphous Nylon | 0.0006 | 2 |
| | | (minimum) | |

When being used to manufacture a container, typically the polymeric material of this embodiment initially is in the form of a parison which is extruded into a preform and blow molded into the desired shape. It is contemplated that this will be done in a conventional manner which is well known to those skilled in the art. The present invention is not limited to a method of extrusion or blow molding.

In a third embodiment of the present invention, a beverage container of the first embodiment, such as that shown in FIGS. 1-6 and described above, is formed of a polymeric material having a seven layer structure of the second embodiment, such as that shown in FIG. 7 and described above. This combination is especially suitable for hot filled beverages, particularly those which are susceptible to development of off flavors when stored for long time periods such as for about six months or more in polymeric containers. The combination is also useful for containers for beverages containing 10 weight percent or more of fruit or citrus juice. Further, the combination is useful for beverages containing fruit or citrus juice and dairy products, such as for example a smoothie beverage with yogurt and fruit juice. In a preferred embodiment, the smoothie beverage includes yogurt, approximately 50 weight percent of fruit juice and other additives.

It will be understood that the embodiments of the present invention which have been described are illustrative of some of the applications of the principles of the present invention. Numerous modifications may be made by those skilled in the art without departing from the true spirit and scope of the invention.

1. A hot filled plastic container comprising:
a bell portion, a body portion and a base;
wherein said bell portion includes a neck for passage of a hot filled food product therethrough and a shoulder portion between said neck and said body portion; and
wherein said body portion is generally rectangular in transverse cross section and includes four panel sections, wherein each of said panel sections is flat and flexible, each said panel section exhibiting flexibility to move between a bowed and a planar configuration in response to temperature changes experienced by the container.

2. The plastic container of claim 1 wherein each panel section is coupled to the adjoining panel section by a smooth, rounded corner.

3. The plastic container of claim 1 wherein said panel sections have no ribs, no stress absorbing strips, no raised areas and no recessed areas.

4. The plastic container of claim 1 further comprising a label engaging said panel sections.

5. The plastic container of claim 4 wherein said label extends from the bottom of said neck to said base, including said panel sections.

6. The plastic container of claim 1 wherein said container is a blow-molded polypropylene container.

7. The plastic container of claim 6, wherein said container is a beverage container which contains a hot filled beverage.

8. The plastic container of claim 1 wherein said container has a top load rating of at least 80 pounds at room temperature or below.

9. The plastic container of claim 1 wherein two opposing side panels have a mold line therein.

10. A multilayer plastic container comprising at least one wall which defines an interior surface and an exterior surface of the container, wherein said wall is formed of seven layers with a first layer of polypropylene, a second layer of adhesive, a third layer of ethylene-vinyl alcohol polymer, a fourth layer of adhesive, a fifth layer of regrind, a sixth layer of adhesive, and a seventh layer of polyamide and wherein said first layer of polypropylene forms the exterior surface of the container and said seventh layer of polyamide forms the interior surface of the container.

11. The plastic container of claim 10 wherein said container is a hot fill plastic container.

12. The plastic container of claim 11 wherein said container is a blow-molded container.

13. The plastic container of claim 10 wherein said fifth layer of regrind forms at least 70% of said wall.

14. The plastic container of claim 13 wherein said first layer of polypropylene forms approximately 20% of said wall.

15. The plastic container of claim 14 wherein said third and seventh layers each form approximately 2% of said wall.

16. A multilayer plastic container formed of a polymeric material, wherein said polymeric material comprises a layer of polypropylene, a layer of ethylene-vinyl alcohol polymer adhered to said layer of polypropylene, a layer of regrind adhered to said layer of ethylene-vinyl alcohol polymer, and a layer of amorphous nylon adhered to said layer of regrind, wherein said layer of amorphous nylon forms the interior surface of the container.

17. The plastic container of claim 16 wherein said container is a hot fill plastic container.

18. The plastic container of claim 16 wherein said layer of regrind forms at least 70% of said polymeric material.

19. The plastic container of claim 18 wherein said layer of polypropylene forms approximately 20% of said polymeric material.

20. The plastic container of claim 19 wherein said layer of ethylene-vinyl alcohol polymer and said layer of amorphous nylon each form approximately 2% of said polymeric material.

21. A hot filled plastic container comprising
a bell portion, a body portion and a base;
wherein said bell portion includes a neck for passage of a hot filled food product therethrough and a shoulder portion between said neck and said body portion, and wherein said body portion is generally rectangular in transverse cross section and includes four panel sections, wherein each of said panel sections is flat and flexible, each said panel section exhibiting flexibility to move between a bowed and a planar configuration in response to temperature changes experienced by the container;
wherein said container is formed of a polymeric material, said polymeric material having a layer of polypropylene, a layer of ethylene-vinyl alcohol polymer adhered to said layer of polypropylene, a layer of regrind adhered to said layer of ethylene-vinyl alcohol polymer, and a layer of amorphous nylon adhered to said layer of regrind; and
wherein said layer of polypropylene forms an exterior surface of the container and said layer of amorphous nylon forms an interior surface of the container which is in contact with the hot filled food product.

22. The plastic container of claim 21 wherein said panel sections have no ribs, no stress absorbing strips, no raised areas and no recessed areas.

23. The plastic container of claim 21 further comprising a label engaging said panel sections.

24. The plastic container of claim 23 wherein said label extends from the bottom of said neck to said base, including said panel sections.

25. The plastic container of claim 21 wherein said container is a blow-molded polypropylene container.

26. The plastic container of claim 25, wherein said container is a beverage container which contains a hot filled beverage that includes at least 10 weight percent of a citrus or fruit juice.

27. The plastic container of claim 27, wherein said hot fill beverage includes approximately 50 weight percent of a citrus or fruit juice.

28. The plastic container of claim 26, wherein said hot fill beverage includes fruit or citrus juice and a dairy product.

29. The plastic container of claim 21 wherein said container has a top load rating of at least 80 pounds at room temperature or below.

30. The plastic container of claim 21 wherein two opposing side panels have a mold line therein.

31. The plastic container of claim 21 wherein said layer of regrind forms at least 70% of said polymeric material.
